(19) United States
(12) Patent Application Publication
(10) Pub. No.: US 2026/0054245 A1
(43) Pub. Date: Feb. 26, 2026

(54) APPARATUS AND METHOD

(71) Applicant: THE UNIVERSITY OF LIVERPOOL, Liverpool (GB)

(72) Inventors: Xin Tu, Liverpool (GB); Weitao Wang, Liverpool (GB); Yichen Ma, Liverpool (GB)

(21) Appl. No.: 18/717,296

(22) PCT Filed: Dec. 8, 2022
(86) PCT No.: PCT/GB2022/053131

§ 371 Date: Jun. 6, 2024

(30) Foreign Application Priority Data
Dec. 8, 2022 (GB) 2117729.0

(51) Int. Cl. B01J 19/08; C01B 21/24; C01B 21/36; C01C 1/02; C25B 1/27; C25B 9/19; C25B 11/075

(52) U.S. Cl. CPC B01J 19/088; C01B 21/24; C01B 21/36; C01C 1/026; C25B 1/27; C25B 9/19; C25B 11/075; B01J 2219/0809; B01J 2219/0815; B01J 2219/0883; B01J 2219/0896

(57) ABSTRACT

According to a first aspect of the present invention, there is provided an apparatus for forming NOx from nitrogen and oxygen, the apparatus comprising: a gliding arc discharge, GAD, device arranged to generate a plasma; a passageway including an inlet for a feed gas comprising nitrogen and oxygen and an outlet for the NOₓ, wherein the passageway extends, at least in part, through the GAD device wherein, in use, the nitrogen and oxygen are reacted in the generated plasma, thereby forming the NOₓ from at least some of the nitrogen and oxygen; and a post-discharge container for adjusting the NO₂/NO ratio in the formed NOₓ to from 1:2 to 2:1.

### FIELD

The present invention relates to an apparatus for and method of nitrogen fixation. Particularly, the present invention relates to an apparatus for and method of nitrogen fixation using a gliding arc discharge (GAD) device. The present invention particularly relates to an apparatus for and method of synthesising ammonia.

### BACKGROUND

Nitrogen is an essential component for all living things as it is a constituent element of nucleic acids. Although elemental nitrogen constitutes approximately 78% of Earth's atmosphere, its chemically inert features make it inaccessible for most organisms. Nitrogen fixation, which converts inert atmospheric nitrogen into chemically useful nitrogen compounds (ammonia, nitric oxides, nitrate, etc.), is a key process for sustaining life on earth. In nature, nitrogen fixation can be achieved by lightning that converts atmospheric nitrogen into NOₓ (NO and NO₂) or biological process that produces ammonia from nitrogen by nitrogenase enzymes, but they fail to provide sufficient fixed N₂ to feed the growing population.

Over the past century, large-scale nitrogen fixation has been achieved and dominated by the industrial Haber-Bosch (HB) process, in which ammonia is synthesized from nitrogen and hydrogen. Unfortunately, the HB process is an energy intensive process with an immense CO₂ footprint, accounting for 1-2% of global energy usage, as it operates at high temperatures (400-600° C.) and high pressures (200-400 atm). It also accounts for more than 1% of global CO₂ emission and utilizes hydrogen from fossil fuels such as natural gas. Therefore, there is a need to develop greener and more sustainable technology for carbon-neutral ammonia production under more moderate conditions, preferentially powered by renewable energy sources.

To this end, electrocatalytic, photocatalytic and plasma (e.g., plasma-electrochemical and plasma-catalytic) technologies have been proposed as alternatives to produce ammonia. Among them, non-thermal plasma (NTP) technology has gained increasing attention for decentralized on-demand nitrogen fixation due to the following advantages. Plasma processes for nitrogen fixation can be operated under ambient pressure and temperature, thus significantly reduce the reactor size and capital costs. Plasma processes can be switched on and off instantly due to fast reactions, offering the great flexibility to be coupled with renewable energy sources such as wind and solar power especially the intermittent renewables. More notably, nitrogen fixation using plasma technology has a lower theoretical limit of energy consumption than the conventional HB process. This is because energetic electrons generated by NTP can activate inert N₂ molecules by electron impact excitation and dissociation to convert N₂ into nitrogen compounds (ammonia, nitric oxides, etc.) without additional heating.

Currently, most studies employing NTP for nitrogen fixation focus on the direct synthesis of ammonia from N₂ and H₂. However, results indicate that this approach suffers from a trade-off between low energy consumption and high ammonia yield. For example, a high NH₃ yield of 6.4% can only be achieved at a very high energy consumption of 81 MJ/mol NH₃, while a low energy consumption of 2 MJ/mol NH₃ is accompanied by an ultra-low yield of NH₃ (<0.1%). However, the separation of NH₃ from such a diluted gas mixture is highly energy intensive. In addition, this process requires expensive green hydrogen to produce CO₂-neutral ammonia.

Therefore, developing greener and sustainable technologies for ammonia production directly from N₂ or air without using hydrogen has attracted increasing interests. The coupling of plasma NOₓ synthesis from air and electrocatalytic reduction of nitrate/nitrite offers a very promising route for ammonia production. In addition, the produced NOₓ from air can also be directly used for the production of fertilizers. Reduction of the energy consumption of NOₓ production and rational design of highly active, selective, and stable electrocatalysts are critical to achieve green and energy efficient ammonia production directly from air.

### SUMMARY OF THE INVENTION

It is one aim of the present invention, amongst others, to provide an apparatus for and method of converting air into gaseous NOₓ, nitrate/nitrite intermediaries, and ammonia as a final product, which at least partially obviates or mitigates at least some of the disadvantages of the prior art, whether identified herein or elsewhere.

For instance, it is an aim of embodiments of the invention to provide an apparatus to provide plasma-assisted synthesis of NOₓ directly from air, with a high NOₓ concentration, adjustable NO₂/NO ratios, and low energy consumption.

For instance, it is an aim of embodiments of the invention to provide an apparatus to provide plasma-assisted synthesis of aqueous nitrate/nitrite intermediaries, with high nitrate/nitrite concentration and adjustable nitrate/nitrite ratios.

For instance, it is an aim of embodiments of the invention to provide a method of synthesising ammonia from NOₓ at low temperature using plasma-electrocatalysis system.

For instance, it is an aim of embodiments of the invention to provide an apparatus for and/or a method of synthesising ammonia that does not require additional heating and can be conducted at ambient pressure.

For instance, it is an aim of embodiments of the invention to provide an apparatus for and/or a method of synthesising ammonia that does not require H₂ as source and does not have a substantial CO₂ footprint.

For instance, it is an aim of embodiments of the invention to provide an apparatus for and/or a method of ammonia production (or NOₓ production) that may be integrated with renewable energy sources (e.g. wind and solar power), especially the use of intermittent renewable energy during peak load for localised or distributed energy storage.

### DETAILED DESCRIPTION OF THE INVENTION

According to the present invention there is provided an apparatus, as set forth in the appended claims. Also provided is a method. Other features of the invention will be apparent from the dependent claims, and the description that follows.

### Apparatus

According to a first aspect, there is provided an apparatus for forming NOₓ from nitrogen and oxygen, the apparatus comprising:
a gliding arc discharge, GAD, device arranged to generate a plasma;
a passageway including an inlet for a feed gas comprising nitrogen and oxygen and an outlet for the NOₓ, wherein the passageway extends, at least in part, through the GAD device wherein, in use, the nitrogen and oxygen are reacted in the generated plasma, thereby forming the NOₓ from at least some of the nitrogen and oxygen; and
a post-discharge container for adjusting the NO₂/NO ratio in the formed NOₓ to from 1:2 to 2:1.

The apparatus is suitable for forming NOₓ from nitrogen and oxygen sourced from, for example, air. Suitably the feed gas is air. In one example the feed gas is dry air, suitably comprising less than 1 wt. % water. The apparatus is suitable for forming gaseous NOₓ. For the avoidance of doubt, the nitrogen and oxygen are provided in gaseous form. Other gases may be used in combination with the nitrogen and oxygen, such as gases commonly found in air, for example argon.

NOₓ defines nitrogen oxides, suitably nitric oxide (NO) and nitrogen dioxide (NO₂).

Other gaseous products may be formed, for example N₂O, N₂O₅ and/or ozone. However, these gaseous products will suitably be present in low amounts and NOₓ will be the major product formed, for example at 90% or more, suitably, 95% or more, for example at 99% or more or 99.9% or more, relative to the total products in mol. %.

The apparatus of the first aspect comprises the GAD device, which may alternatively be referred to as a gliding arc plasma device.

Gliding arc plasma is a type of non-thermal and non-equilibrium plasma. Compared to other types of non-thermal plasma, gliding arc has a very high electron density of ˜10²³ m⁻³ (close to thermal plasma) which results in a desirable energy efficiency for chemical synthesis such as nitrogen fixation.

Typically, the gliding arc plasma device comprises two divergent electrodes, where the arc starts at the shortest distance between the electrodes, then driven by the gas flow and the length of the arc column increases together with the voltage. The electrical potential to trigger and sustain the gliding arc discharge can be supplied by direct current (DC), alternating current (AC) or pulsed power supply source. It should be understood that the electrodes are thus electrical conductors. The electrodes may be any suitable metal.

Suitably, the gliding arc discharge device of the present invention is supplied by an alternating current (AC).

In one example, the gliding arc discharge device comprises a pair (i.e. two) of thin diverging stainless steel electrodes. The electrodes may suitably be elliptically-shaped, such as a quarter of an ellipse. The electrodes having a quarter-elliptical shape will suitably have a minor axis and a major axis, for example the electrodes may have a minor axis length of 40 mm and a major axis length of 80 mm. The electrodes suitably have a thickness of up to 5 mm, such as 4 mm or up to 3 mm. In one example, the electrodes have a thickness of 3 mm. The electrodes are suitably fixed symmetrically on a support, such as a transparent quartz support. However, any suitable support may be used. The support is suitably flat.

In one example, the support has a thickness of up to 15 mm, suitably up to 12 mm or up to 10 mm. In one example, the thickness of the support is 10 mm. The support suitably has a thickness of up to 5 mm, such as up to 4 mm or up to 3 mm. In one example, the support has a thickness of 2 mm. The support suitably comprises a rectangular cross-section.

However, these dimensions may be modified accordingly with the size of the gliding arc discharge device and scaled-up or down accordingly.

The feed gas (which comprises nitrogen and oxygen, suitably air) is introduced through a nozzle. The nozzle is suitably cylindrical with a diameter of up to 5 mm, for example up to 2 mm. In one example, the nozzle has a diameter of 1 mm. The nozzle is suitably positioned above the tip of the electrodes, such as positioned at 5 mm above the tip of the electrodes, where the narrowest gap distance is 2 mm.

In one example, the feed gas uses a mixture of nitrogen and oxygen with different N₂/O₂ ratios, which is controlled by changing the gas flow rates of nitrogen and oxygen while keeping the total flow rate the same. In one example, the flow rate ratio of N₂ to O₂ is 1.5. In one example, the flow rate ratio of N₂ to O₂ is 4, i.e. similar to the ratio found in air.

The gas flow rates of nitrogen and oxygen are controlled by a nitrogen mass flow controller with a gas flow range of 0.05-1 SLM and an oxygen mass flow controller with a gas flow range of 0.05-1 SLM. In one example, the feed gas uses air, and the flow rate is controlled by a mass flow controller with a range of 0.5-10 SLM.

In one example, the gas pressure is controlled by a gas regulator. In one example, the pressure is atmospheric pressure.

In one example, the GAD device is powered by a pulsed power supply source with a voltage range of 0-20 kV, a pulse width range of 1 ns-1 ms, a rising time of 50 ns, a falling time of 50 ns, and/or a frequency range of 1 Hz-100 kHz. In one example, the GAD device is powered by an AC power supply source with a peak-to-peak voltage range of 0-10 kV, which is regulated through a transformer, and a fixed frequency of 50 Hz or optionally an adjustable frequency range from 1 Hz to 100 kHz. When the GAD device is powered by the power supply, one of the electrodes in GAD is suitably grounded, and another one is suitably connected to the high voltage output of the power supply.

In one example, the apparatus comprises a source of external heat to provide additional heat to the reaction when in use. However, this is not preferred. In one preferred example, the apparatus does not comprise an, or any, external heating source(s).

The apparatus may comprise additional safety features. For example, the apparatus may comprise an additional cooling source to reduce temperature when the apparatus is in use. However, this is not preferred. In a preferred example, the apparatus does not comprise any cooling sources.

For example, conventional apparatuses often operate at high temperatures and are therefore energy-intensive. Additionally and/or alternatively, conventional apparatus typically requires cooling, since direction is exothermic, to attenuate heating. In contrast, the apparatus according to the first aspect may not require additional cooling since the reaction temperature is relatively low.

The GAD device may comprise a catalyst. In one example the GAD device does not comprise a catalyst.

The apparatus comprises a post-discharge container for adjusting the NO₂/NO ratio in the formed NOₓ to from 1:2 to 2:1. In one example, the NO₂/NO ratio is 1:1.

In one example, the post-discharge container is fluidically coupled to the outlet of the GAD device. In one example, the post-discharge container and the GAD device are coupled by connecting the inlet of the post-discharge container and the outlet of the GAD device using a high temperature resistant tube.

In one example the tube is a rubber tube.

The inventors have established that the NO₂/NO ratio in NOₓ may be controlled by changing the dimensions of the post-discharge container. Suitably, the post-discharge container is a cylindrical post-discharge container.

In one example, the cylindrical post-discharge container has a length of 1000 mm, an inner diameter of 4 mm, and an outer diameter of 6 mm, with a total volume of 50 cm³. In one example, the cylindrical post-discharge container has a length of 5000 mm, an inner diameter of 4 mm, and an outer diameter of 6 mm, with a total volume of 250 cm³. In one example, the cylindrical post-discharge container has a length of 15000 mm, an inner diameter of 4 mm, and an outer diameter of 6 mm, with a total volume of 755 cm³.

In one preferred example, the post-discharge container is a cylindrical container made from a plastics material, for example acrylic. However, any suitable material can be used.

In one example, the post-discharge container comprises a micro-porous membrane dividing the container into two parts. Suitably a solution, for example an aqueous solution, may be added to one part of the post-discharge container to absorb the produced NOₓ from GAD device. The second part of the post-discharge container comprises the produced NOₓ.

The micro-porous membrane allows the penetration of gaseous NOₓ into the solution while prohibiting the penetration of aqueous solution into the gaseous part. Any suitable membrane material may be used. In one example, the membrane is metal, such as nickel, cobalt or stainless steel.

In one example, the diameter of the micro-porous membrane is from 10 to 100 mm, for example from 20 to 80 mm, such as 60 mm.

In one example, the thickness of the membrane is from 0.05 to 0.5 mm, for example from 0.1 to 0.3 mm, such as 0.2 mm.

In one example, the pitch of the micro-porous membrane is from 350 to 500 μm, for example from 380 to 480 μm, such as 450 μm or 480 μm.

In one example, the pore size is from 5 to 100 μm, for example from 10 to 70 μm, such as 20 μm or 50 μm.

In one example, the diameter of the micro-porous membrane is 60 mm; the thickness of the membrane is 0.2 mm; the pitch of the micro-porous membrane is 450 μm, and the pore size is 50 μm. In one preferred example, the diameter of the micro-porous membrane is 60 mm; the thickness of the membrane is 0.2 mm; the pitch of the micro-porous membrane is 480 μm, and the pore size is 20 μm.

In one example, the diameter of the container is 70 mm, and the height of the container is 120 mm.

The apparatus may further comprise a means for converting the NOₓ to ammonia. In one example, the apparatus comprises an electrochemical means, suitably an electrochemical means comprising a H-type cell arranged as a divided electrochemical cell.

In one example, the divided electrochemical cell comprises two compartments which are connected through a diaphragm, ion-permeable membrane or salt bridge. Suitably, one compartment is known as the working compartment. The other compartment is known as the counter compartment.

Suitably, both the working and counter compartments comprise an electrolyte. Suitably, a working electrode and a reference electrode are placed into the electrolyte in the working compartment. Suitably, a counter electrode is placed into the electrolyte in the counter compartment.

In one example, the reference electrode is a Hg/HgO or saturated calomel electrode (SCE) electrode. In one example, the counter electrode comprises platinum. The counter electrode may suitably be a platinum foil.

In one example, the diaphragm comprises and/or is a sulfonated tetrafluoroethylene based fluoropolymer-copolymer membrane, for example a circular Nafion™ perfluorinated membrane.

In use, the electrochemical means allows for the electrochemically reduction of the nitrate/nitrite solution obtained from the post-discharge container at certain potential on the working electrode, thereby generating ammonia and other minor products such as nitrite, for example 10% or less, when nitrate is present in the working electrolyte.

The working electrode may comprise an electrocatalyst, suitably an electrocatalyst comprising a transition metal, for example cobalt or nickel. The electrocatalyst will suitably be provided on a support.

In one example, the support comprises and/or is a carbon cloth, for example CeTech wos1009. In one example, the support is a commercial carbon paper, such as Toray TGP-H-060. In one example, the support is a nickel foam.

In one example, the electrocatalysts comprising cobalt or nickel are synthesised by electro-deposition method. In one example, the electrocatalysts are synthesised in a single chamber cell at 20° C. using a conductive substrate as a working electrode, a SCE as a reference electrode and a platinum foil as a counter electrode.

In one example, the catalyst comprises a Co(OH)₂ nano-array. Suitably, the Co(OH)₂ nano-array may be directly electro-deposited on carbon paper from aqueous solution of cobalt nitrate hexahydrate at a potential of −1.0 V versus SCE.

In one example, the catalyst comprises a Ni(OH)₂ nano-array. Suitably, the Ni(OH)₂ nano-array may be directly electro-deposited on carbon paper from aqueous solution of nickel nitrate hexahydrate at a potential of −1.0 V versus SCE.

In one example, the catalyst comprises a Co—Ni(OH)₂ nano-array. Suitably, the Co—Ni(OH)₂ nano-array may be directly electro-deposited on carbon paper from a mixed aqueous solution of cobalt nitrate hexahydrate and nickel nitrate hexahydrate at a potential of −1.0 V versus SCE.

The inventors have established that an electrocatalyst comprising cobalt is particularly suitable for nitrate/nitrite reduction towards ammonia. The conductive substrate may affect the catalytic performance of the electrocatalysts.

In one example, the catalyst comprises a Co(OH)₂ nano-array, which is directly electro-deposited on carbon cloth from an aqueous solution of cobalt nitrate hexahydrate at a potential of −1.0 V versus SCE.

In one example, the catalyst comprises a Co(OH)₂ nano-array, which is directly electro-deposited on nickel foam from an aqueous solution of cobalt nitrate hexahydrate at a potential of −1.0 V versus SCE.

The inventors have established that a nickel foam substrate is particularly suitable for electrochemical reduction of nitrate/nitrite towards ammonia.

In one example, the catalyst comprises a Co₃O₄ nano-array, which may be synthesised by annealing the Co(OH)₂ deposited on nickel foam at 300° C. for 120 min with a heating rate of 2° C./min.

In one preferred example, the catalyst comprises Co. In one especially preferred example, the catalyst consists essentially of Co metal film. The Co film catalyst may be directly electro-deposited on a nickel foam from a mixed solution of cobalt chloride hexahydrate, boric acid, and ammonium citrate dibasic at a current density of 1 A/dm².

In one example, no extra device is used to change the state (i.e. motion) of the working solution and the working solution is defined as static. In one preferred example, a magnetic stir and a magnetic stir bar are used to stir the working solution, for example, at 400 rpm. Suitably the working solution may be defined as flowing.

In one example, Hg/HgO is used as reference electrode when electrolysis is performed in an alkaline solution, for example, 1 M KOH. In one example, SCE is used as reference electrode when electrolysis is performed in a neutral solution, for example, 0.5 M K₂SO₄.

The apparatus may comprise additional safety features. For example, the apparatus may comprise a heating source to raise temperature when the apparatus is in use. However in preferred examples a heating source is not needed. In one example, the apparatus is used at low temperature and thus no additional heating sources are needed.

This offers a significant advantage over conventional apparatuses, which often operate at high temperatures and high pressures and are therefore energy-intensive. Additionally and/or alternatively, conventional apparatuses for ammonia production typically require H₂ as resource, which usually originates from CH₄, therefore has a CO₂ footprint. In contrast, the apparatus according to the first aspect does not require H₂.

### Method

According to a second aspect of the present invention, there is provided a method of forming NOₓ from nitrogen and oxygen, the method comprising:
generating a plasma using a gliding arc discharge, GAD, device; and
reacting the nitrogen and oxygen in the generated plasma, thereby forming the NOₓ from at least some of the nitrogen and oxygen
adjusting the NO₂/NO ratio in the formed NOₓ to from 1:2 to 2:1.

In one example, the method is carried out using an apparatus according to the first aspect.

The NOₓ, the nitrogen, the oxygen, the plasma and the GAD device may be as described with respect to the first aspect. The method may include any of the steps and/or features described with respect to the first aspect, mutatis mutandis.

Suitably adjusting the NO₂/NO ratio in the formed NOₓ will be carried out in the post-discharge container according to the first aspect.

According to a further aspect of the present invention, there is provided a method of synthesising ammonia, the method comprising:
(a) reacting the NOₓ obtained from the method of the second aspect with an aqueous solution to form nitrate/nitrite from at least some of the NOₓ; and
(b) electrochemically reducing the nitrate/nitrate obtained in step (a) to ammonia.

Suitably step (a) will be performed in the post-discharge container defined according to the second aspect.

Suitably step (b) will be performed using the electrochemical means defined in the first aspect, suitably a H-type cell.

Suitably step (b) involves applying a potential on the working electrode in a H-type cell and the nitrate/nitrite will be electrochemically reduced to ammonia. Suitably step (b) occurs on a catalyst comprising cobalt and/or nickel, suitably consisting essentially of cobalt, supported on a conductive substrate.

The reaction temperature of the second aspect (i.e. the temperature at which the nitrogen and oxygen are exposed to the generated plasma) is at most 400° C., and more preferably at most 300° C. or at most 250° C. The reaction temperature may suitably be described as “low” temperature.

In one example, the method comprises externally heating the nitrogen and oxygen, for example using an external source of heat. However, this is not preferred. In one preferred example, the method comprises no external heating. In this way, the reaction temperature is provided, for example at least partly and/or fully, by the generated plasma.

The method according to the second aspect offers a significant advantage over conventional methods as the reaction may be performed at relatively low temperatures, without an external source of heat. This reduces the energy consumption and capital cost of the process. Additionally and/or alternatively, it is not necessary to remove heat from the process or provide processes to prevent overheating of the process.

Additionally and/or alternatively, since the reaction may be performed at relatively low temperatures, the method may be initiated (i.e. switched on) and/or paused or terminated (i.e. switched off) on demand, for example immediately or instantly, since pre-heating is not required, for example.

Since the generated plasma reaches a stable state in a relatively short time, the method may be stopped and subsequently restarted without any additional waiting time, improving an efficiency of the process. In this way, the process provides great flexibility to be integrated with renewable energy sources such as wind and solar power, especially the use of intermittent renewable energy during peak load for localised or distributed energy storage.

The reaction pressure (i.e. the pressure at which the nitrogen and oxygen, suitably air, is exposed to the generated plasma) is approximately ambient pressure. It should be understood that approximately ambient pressure is the substantially natural pressure of the environment, for example about 101 kPa.

In one example, the method comprises exposing the nitrogen and oxygen, suitably air, to the generated plasma in the presence of other gases, for example inert gases such as argon. In one example only pure nitrogen and oxygen are used. In one example, air is used.

In one example, the N₂/O₂ ratio of the feed gas is in a range of from 0.05 to 19, preferably in a range from 0.67 to 4. In one preferred example, the feed gas is air comprising nitrogen and oxygen at usual atmospheric levels. Using air means that no additional energy is needed to prepare the feed gas.

The power of the discharge may be defined by Equation (1):

$$P = \frac{1}{τ} {\int }_{0}^{τ} V ( t ) \times I ( t ) dt \qquad ( 1 )$$

Where τ is a time period of discharge, V(t) is the arc voltage and I(t) is the discharge current. In one example, the power of the discharge, as define by Equation (1), is in a range of from 6 W to 41 W, preferably in a range of from 15 W to 30 W with the frequency of the power supply at 40 KHz.

The energy consumption of NOₓ production may be defined by Equation (2):

$$E {C}_{N {O}_{x}} ( MJ / mol ) = \frac{P ( W )}{{C}_{N {O}_{X}} ( ppm ) \times {F}_{gas} ( L / min ) \times \frac{1}{24.5 L / mol} \times 1 {0}^{- 6} \times \frac{1}{60}} \times 1 {0}^{- 6} \qquad ( 2 )$$

Where C_{NO}_{ₓ} is the concentration of NOₓ, F_{gas} is the feed gas flow rate, and 24.5 L/mol is the molar volume of ideal gas at 1 atm, 298 K.

In one example, the energy consumption of NOₓ production EC_{NO}_{ₓ}, as defined by Equation (2), is at most 17.6 MJ/mol, preferably at most 1.5 MJ/mol, more preferably at most 1.2 MJ/mol.

In one example, the flow rate of the air is in a range from 0.5 SLM to 4 SLM, preferably in a range of 1 SLM to 2 SLM with the frequency of the power supply at 40 KHz.

In one example, the circuit of the GAD device comprises a 100 kΩ resistance to restrict the discharge current. In one preferred example, the circuit of the GAD device comprises no resistance. In this way, the energy consumption of NOₓ production is reduced because no extra energy is needed for the resistance.

The energy consumption of nitrate/nitrite production in the post-discharge container may be defined by Equation (3):

$$E {C}_{nitrate / nitrite} ( MJ / mol ) = \frac{P ( W ) \times t ( s )}{{c}_{nitrate / nitrite ( mol / L ) \times V ( L )}} \times 1 {0}^{- 6} \qquad ( 3 )$$

Where P is the discharge power, t is the time period of the discharge, C_{nitrate/nitrite} is the concentration of nitrate/nitrite, and V is the volume of the solution (0.1 L).

In one example, the energy consumption of NOₓ production EC_{nitrate/nitrite}, as defined by Equation (3), is at most 6.5 MJ/mol, preferably at most 4.7 MJ/mol, more preferably at most 3.5 MJ/mol.

Since the generated plasma reaches a stable state in a relatively short time, the method may be stopped and subsequently restarted without any additional waiting time, improving an efficiency of the process. In this way, the process provides great flexibility to be integrated with renewable energy sources such as wind and solar power, especially the use of intermittent renewable energy during peak load for localised or distributed energy storage. In one example, the power supply source is connected to a portable solar generator.

The potentials for H-type cell may be described versus the reversible hydrogen electrode (RHE) via the following equations:

$${E}_{R H E} = {E}_{Hg / HgO} + 0.098 + 0.0 \; 59 \times pH \qquad ( 4 )$$

$${E}_{R H E} = {E}_{S C E} + 0.2412 + 0.059 \times p H \qquad ( 5 )$$

In one example, electrolysis is performed at a working electrode potential, as defined by Equation (4) and Equation (5), ranging from 0.2 V versus RHE to −1.0 V versus RHE to determine the suitable potential for ammonia production.

In one example, electrolysis is performed at a K₂SO₄ concentration of 0.5 M. In one example, electrolysis is performed at a KOH concentration of 0.1 M and a K₂SO₄ concentration of 0.45 M. In one example, electrolysis is performed at a KOH concentration of 0.5 M and a K₂SO₄ concentration of 0.25 M. In one preferred example, electrolysis is performed at a KOH concentration of 1 M.

In one example, electrolysis is performed at a nitrate/nitrite concentration of from 0.005 M to 0.2 M to determine the suitable concentration of nitrate/nitrite for ammonia production.

The Faradaic efficiency FE_{NH}_{₃} toward NH₃ production may be defined by Equation (6):

$${FE}_{{NH}_{3}} ( \% ) = \frac{{M}_{N {H}_{3}} \times n \times F}{Q} \times 100 \qquad ( 6 )$$

Where M_{NH}_{₃} is mole of ammonia measured, n is 8 for ammonia formation from nitrate reduction or 6 for ammonia formation from nitrite reduction, F is the Faraday constant (96485 C/mol), and Q is the total charge passed.

In one example, the method has a Faradaic efficiency FE_{NH}_{₃}, as defined by Equation (6), of at least 80%, preferably at least 90%, more preferably at least 95%.

The ammonia production rate (mmol/h/cm² or mg/h) at specific applied potentials may be defined by Equations (7) and (8):

$${R}_{N {H}_{3}} = \frac{j \times F E}{n \times F} \times 3600 \qquad ( 7 )$$

$${R}_{N {H}_{3}} = \frac{j \times F E \times 17 \times S}{n \times F} \times 3600 \qquad ( 8 )$$

Where j is the current density (mA/cm²), n is 8 for ammonia formation from nitrate reduction or 6 for ammonia formation from nitrite reduction, FE is the Faradaic efficiency, 17 is the molar mass of ammonia, and S is the area of the working electrode.

In one example, the method has an ammonia production rate R_{NH}_{₃}, as defined by Equation (7), of at least 3 mmol/h/cm², preferably at least 4 mmol/h/cm², more preferably at least 5 mmol/h/cm².

The energy consumption of ammonia production from nitrate/nitrite in the electrolysis may be defined by Equation (9):

$${EC}_{{NH}_{3}} ( MJ / mol ) = \frac{{U}_{E} \times {I}_{E} \times T}{{M}_{N {H}_{3}}} \times 1 {0}^{- 6} = \frac{{U}_{E} \times n \times F}{F E} \times 1 {0}^{- 6} \qquad ( 9 )$$

Where UE is the potential of the working electrode versus RHE in the electrolysis, IE is the current of the electrolysis, n is 8 for ammonia formation from nitrate reduction or 6 for ammonia formation from nitrite reduction, F is the Faraday constant (96485 C/mol), T is the time period of the electrolysis, and M_{NH3} is mole of ammonia measured.

In one example, the energy consumption of ammonia production from nitrate/nitrite in the electrolysis EC_{NH}_{₃}, as defined by Equation (9), is at most 0.61 MJ/mol, preferably at most 0.32 MJ/mol, more preferably at most 0.06 MJ/mol.

The total energy consumption T_{ECNH}_{₃} of ammonia production from air in the method using the plasma process and the electrolysis process may be defined by Equation (10):

$${T}_{E {C}_{N {H}_{3}}} ( MJ / mol ) = E {C}_{n i t r α t e / n i t r i t e} + E {C}_{N {H}_{3}} \qquad ( 10 )$$

Where EC_{nitrate/nitrite} is the energy consumption of nitrate/nitrite production in the acrylic cylindrical container and EC_{NH}_{₃} is the energy consumption of ammonia production from nitrate/nitrite in the electrolysis.

However, as will be appreciated by the skilled person, the values described herein can be modified.

### Use

According to a further aspect of the present invention, there is provided the use of a catalyst comprising Co metal film in the electrochemical reduction of nitrate and/or nitrite to ammonia.

The Co metal film, electrochemical reduction, the nitrate, the nitrite and the ammonia may be as described with respect to the first and/or second aspect and/or further aspects. The use may include any of the steps and/or features described with respect to the first and/or second aspect and/or further aspects, mutatis mutandis.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1A schematically depicts the experimental setup;

FIG. 2A shows the NOₓ concentration at different N₂/O₂ ratios; FIG. 2B shows the energy consumption of NOₓ production and NO selectivity at different N₂/O₂ ratios, for a gas flow rate of 1 SLM; a power of 17 W and an applied voltage frequency of 6 kHz;

FIG. 3 shows the NOₓ concentration and energy consumption of NOₓ production at different applied voltage frequencies, for an air gas flow rate of 1 SLM, a power of 15 W;

FIG. 4A shows digital photos of gliding arc discharge with increasing power under an applied voltage frequency of 6 KHz; FIG. 4B shows the digital photos of gliding arc discharge with increasing power under an applied voltage frequency of 11 kHz; FIG. 4C shows the digital photos of gliding arc discharge with increasing power under an applied voltage frequency of 40 kHz;

FIG. 5A shows the NOₓ concentration at different discharge powers and frequencies; FIG. 5B shows the NO and NO₂ selectivity at different discharge powers and frequencies; FIG. 5C shows the energy consumption of NOₓ production at different discharge powers and frequencies, for a gas flow rate of 1 SLM.

FIG. 6A shows digital photos of gliding arc discharge upon increasing power using a 100 kΩ resistance in the circuit; FIG. 6B shows the digital photos of gliding arc discharge upon increasing power without using a 100 kΩ resistance in the circuit, at an applied voltage frequency of 6 kHz, for a gas flow rate of 1 SLM

FIG. 7A shows the NOₓ concentration, energy consumption of NOₓ production using or without using a 100 kΩ resistance; FIG. 7B shows NOₓ selectivity using or without using a 100 kΩ resistance, for a gas flow rate of 1 SLM and an applied voltage frequency of 6 kHz;

FIG. 8A shows the digital photos of gliding arc discharge upon increasing the flow rate at an applied frequency of 40 kHz at a fixed power of 18 W; FIG. 8B shows digital photos of gliding arc discharge upon increasing the flow rate at an applied frequency of 6 kHz at a fixed power of 21 W;

FIG. 9A shows the NOₓ concentration, energy consumption of NOₓ production at different flow rates; FIG. 9B shows the NO selectivity at different flow rates and, for frequencies of 6 kHz and 40 kHz, at fixed powers of 21 W and 18 W;

FIG. 10A shows pH and conductivity of aqueous solution in the acrylic cylindrical container at different discharge times using water as the absorbing solution; FIG. 10B shows concentrations of nitrate and nitrite in the aqueous solution at different discharge times using water as the absorbing solution; FIG. 10C shows concentrations of nitrate and nitrite in the aqueous solution at different discharge times using 1 M KOH as the absorbing solution; at a discharge power of 18 W and a flow rate of 1.5 SLM;

FIG. 11 shows LSV curves of Co(OH) 2 on different conductive substrate (carbon cloth, carbon paper and Ni foam) in the electrolysis producing ammonia from nitrate;

FIG. 12 shows LSV curves of Co(OH)₂/Ni foam, Co/Ni foam, and Co₃O₄/Ni foam in the electrolysis producing ammonia from nitrate;

FIG. 13A shows LSV curves of Co/Ni foam at different concentrations of nitrate (concentration of KOH=1 M); FIG. 13 B shows faradaic efficiency toward ammonia production from 0.2 to −1.0 V in 1 M KOH containing different concentrations of nitrate; FIG. 13C shows LSV curves of Co/Ni foam at different concentrations of nitrite (concentration of KOH=1 M); FIG. 13 D shows faradaic efficiency toward ammonia production from 0.2 to −1.0 V in 1 M KOH containing different concentrations of nitrite;

FIG. 14A shows LSV curves of Co/Ni foam at different concentrations of KOH using nitrate solution (concentration of nitrate=0.1 M); FIG. 14B shows faradaic efficiency toward ammonia production from 0.2 to −1.0 V in different concentrations of KOH containing 0.1 M nitrate; FIG. 14C shows LSV curves of Co/Ni foam at different concentrations of nitrite using nitrite solution (concentration of nitrite=0.1 M); FIG. 14D shows faradaic efficiency toward ammonia production from 0.2 to −1.0 V in different concentrations of KOH containing 0.1 M nitrite;

FIG. 15A shows LSV curve of Co/Ni foam using plasma-activated solution in the acrylic cylindrical container (discharge time=30 min, 1 M KOH as absorbing solution, discharge power=18 W, flow rate=1.5 SLM);

FIG. 16A shows the effect of discharge power on the NOₓ concentration; FIG. 16B shows the effect of discharge power on the energy consumption for the production of NOₓ (air GAD, 50 Hz, total gas flow rate 2.8 SLM);

FIG. 17A shows the effect of total gas flow rate on the NOₓ concentration; FIG. 17B shows the effect of total gas flow rate on the energy consumption for the production of NOₓ (air GAD, 50 Hz, discharge power 28 W).

### EXAMPLES

### Experimental

The following procedures were used in the examples which follow.

The arc voltage was measured by a high voltage probe (Tektronix P6015A), while the current was measured by a current monitor (Pearson 2877). The electrical signals (arc voltage, current) were recorded by a four-channel digital oscilloscope (Tektronix MDO 3054, 500 MHZ, 2.5 GS/s) at a sampling rate of 5 Mpts per record to ensure precise measurement.

The gaseous reaction products were analyzed online using a Fourier transform infrared (FTIR) spectrometer (Bruker Tensor II) at a wavenumber resolution of 2 cm⁻¹, and each spectrum was obtained by averaging 16 scans. The absorption spectra were recorded 10 minutes after the discharge ignition to ensure a stable discharge, and each measurement was repeated at least three times. For quantitatively analyzing the concentrations of NOₓ, precise calibration gas mixtures (NO or NO₂ in Argon) with a wide range of concentrations were introduced to the gas cell by mass flow controllers.

The concentrations of aqueous nitrate, nitrite and ammonia were measured by spectrophotometric method using a microplate reader (Thermo Scientific Varioskan® Flash Reader). For the detection of nitrite, 100 μL Griess reagent was added into 100 μL sample, and the absorbance was measured at 540 nm. For the detection of nitrate, 100 μL saturated VCl3 was added into the sample, after which 100 μL Griess reagent was added into the above solution, and the absorbance was measured at 540 nm after the solution was incubated at 37° C. for 12h to insure fully reduction of nitrate by VCl₃. Finally the nitrate concentration was obtained by subtracting the nitrite concentration from the total concentration of nitrate and nitrite. For detection of ammonia, 100 μL potassium sodium tartrate was added into 100 μL sample and then 100 μL Nessler reagent was added into the above solution, and the absorbance was measured at 420 nm. All the measurements were calibrated by using the standard curves.

### Examples: Ammonia Production Via Plasma-Electrolysis Process

### Example 1: NOₓ Production at Different N₂/O₂ Ratios

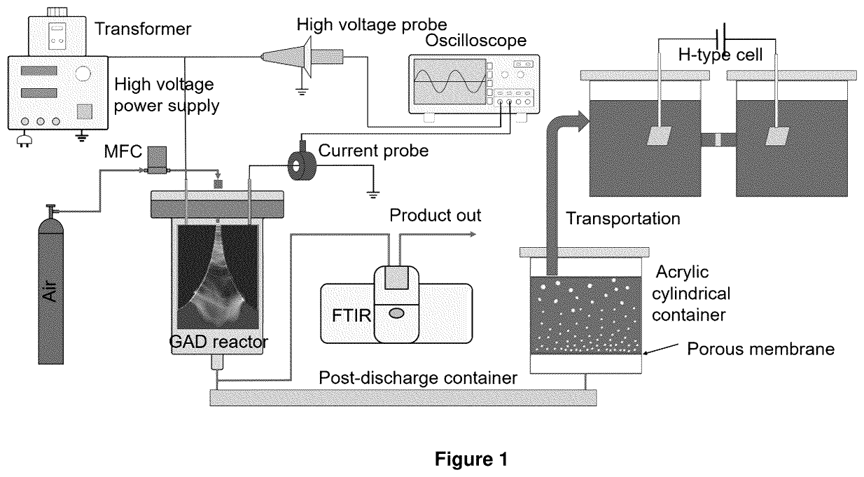

FIG. 1 schematically depicts the experimental setup. The experiments were conducted in a flat gliding arc reactor that used either a mixture of nitrogen and oxygen or dry air as feed gas under atmospheric pressure.

The gliding arc reactor consists of two thin diverging stainless steel electrodes (thickness of 3 mm) fixed symmetrically in a transparent flat (thickness of 10 mm) quartz container with a rectangular cross-section (100×60 mm) to achieve a uniform drag and high processing fraction of the arc column by the surrounding gas flow. The feed gas is introduced through a cylindrical nozzle with a diameter of 1 mm, and the nozzle is 5 mm above the tip of the electrodes, where has the narrowest gap distance of 2 mm.

Feed gas: mixture of N₂ and O₂; gas flow rate: 1 SLM; discharge power: 17 W; applied voltage frequency: 6 KHz.

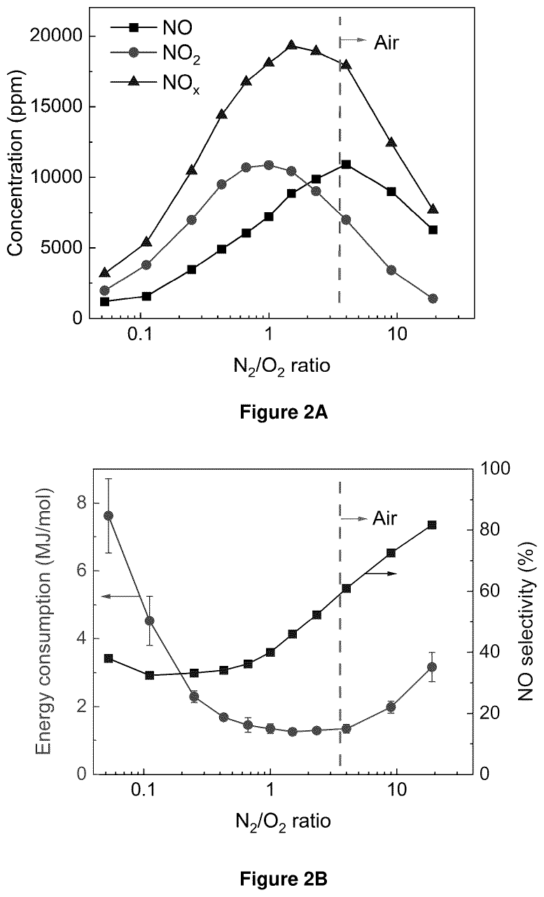

FIG. 2A shows the measured NOₓ (NO and NO₂) concentrations as different N₂/O₂ ratios. The NO and NO₂ concentrations both follow parabolic trends with increasing N₂ fraction. The NO concentration increases upon increasing N₂ fraction until a maximum value of 10900 ppm is reached at a N₂/O₂ ratio of 4, while the NO₂ concentration reaches its maximum (10850 ppm) at a N₂/O₂ ratio of 1.5.

FIG. 2B shows the selectivity of NO and energy consumption of NOₓ production as a function of N₂/O₂ ratio. At N₂/O₂ ratios of lower than 0.11, increasing the N₂ fraction leads to a slightly lower NO selectivity. After this point, the NO selectivity increases upon varying the N₂/O₂ ratio as NO₂ production by NO oxidation is less favoured at low O₂ fractions and the highest N₂/O₂ ratio gives the highest NO selectivity of 81.6%. Energy consumption for NOₓ production drops sharply upon increasing N₂ fraction when the N₂/O₂ ratio is lower than 0.43 and it continues to decrease to a minimum value of 1.26 MJ/mol when it reaches the optimum N₂/O₂ ratio (1.5), after which energy consumption begins to increase. Clearly, too much or too little N₂ is unfavorable for efficient NOₓ generation because both N₂ and O₂ are precursors for NO and NO₂ formation.

Interestingly, at a N₂/O₂ ratio of 4, similar to the composition of air, the energy consumption (1.35 MJ/mol) is only 7% higher than the optimised N₂/O₂ feed ratio, making air a suitable feed gas for NOₓ production as no additional energy is needed to prepare pure O₂ and N₂. Consequently, in the following experiments, we focus on NOₓ production only using air as the feed gas.

### Example 2: NOₓ Production at Different Frequencies

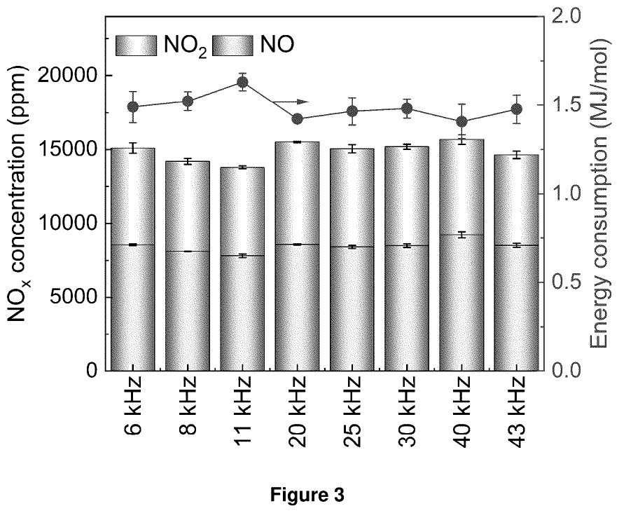

FIG. 3 compares NOₓ production performances under different applied voltage frequencies at a fixed discharge power (feed gas: air; gas flow rate: 1 SLM; discharge power: 15 W). Clearly, higher or lower applied voltage frequencies do not necessarily lead to a higher NOₓ production. 40 KHz frequency give the best performance, where the NOₓ concentration and energy consumptions of NOₓ production can reach 15500 ppm and 1.41 MJ/mol, respectively. Similar results can be seen at 20 kHz. While 6 kHz, 25 kHz, 30 kHz, and 43 kHz frequencies show slightly worse performances and the worst NOₓ production performances is observed at 11 kHz.

### Example 3: NOₓ Production at Different Discharge Powers and Frequencies

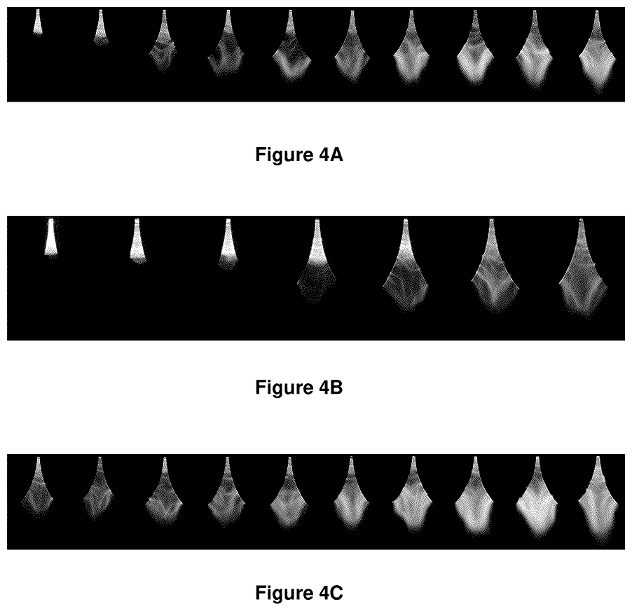

FIG. 4 shows that the gliding arc showed different phenomena at different frequencies with increasing discharge power (feed gas: air; gas flow rate: 1 SLM).

FIG. 4A shows the digital photos of gliding arc discharge with increasing power at a frequency of 6 kHz. Under the lowest discharge power, the arc can only propagate to a short distance; with increasing power from 8 W to 11 W, the propagation distance and the arc length increase significantly and further increasing the power only slightly increases the propagation distance but lead to a larger plasma volume and more diffuse appearance. The discharge contains a large number of bright filamentous arcs at low powers in the upstream of the gliding arc. The evolution process from a mode containing numberless short bright arcs (short arc mode) to a mode that contains long propagated arcs (diffuse mode) upon increasing power was also observed at frequencies of 8 kHz, 11 kHz, 25 kHz, 30 kHz, and 43 kHz. This short arc mode is most remarkable at 11 kHz, where the arcs in the upstream are even brighter and hard to drag down as shown in FIG. 4B. Interesting but differently, the discharge cannot sustain itself in the short arc mode at frequencies of 20 KHz and 40 KHz. As shown in FIG. 4C, the gliding arc discharge directly appears in diffuse mode at the lowest discharge power and the arc propagates slightly downwards upon increasing power.

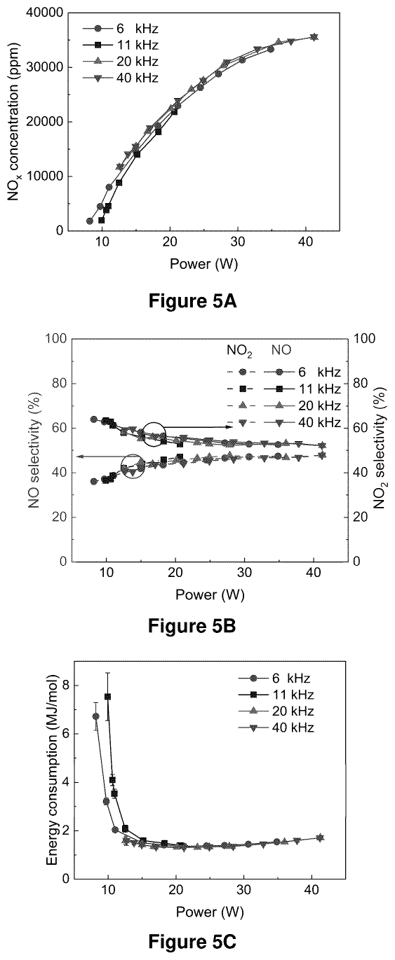

FIG. 5 shows the NOₓ concentrations, NOₓ selectivity and energy consumption of NOₓ production at different frequencies as a function of discharge power. In FIG. 5A, it can be seen that the NOₓ concentrations increase, more quickly at low discharge powers, upon higher discharge powers for all the frequencies. The highest NOₓ concentrations are always observed at 20 KHz and 40 kHz at a fixed discharge power. While 11 kHz sees the lowest NOₓ concentrations, consistent with the above results. Clearly, frequency does affect NOₓ production, but the NOₓ production of the best frequency is only 5% higher than that of the worst frequency at high powers. Note that for frequencies of 6 kHz and 11 kHz, the highest discharge power can be attained are 35 W and 21 W, respectively.

FIG. 5B depicts the effects of frequency and discharge power on NOₓ selectivity. For all the frequencies, increasing the power leads to a remarkably NO₂ selectivity (lower NO selectivity) under low powers (<24 W), and a further power increase only slightly increases NO selectivity. This can be partly explained by the fact that increase the power leads to a longer propagation distance and a larger volume of the plasma region as stated before. As a result, the previous formed NO molecules are more likely oxidized by excited O₂ into NO₂ with a longer residence time in the plasma region. As shown in FIG. 4, the propagation distance increases significantly under low powers, consistent with the increasing NO₂ selectivity upon increasing power. The highest and lowest NO₂ selectivities are 36.1% and 47.8%, which are achieved at 6 kHz with the lowest power and 40 kHz with the highest power.

In FIG. 5C, the calculated energy consumption for NOₓ production drops sharply upon increasing power (<15 W) for frequencies of 6 kHz, 11 kHz. The rapid decrease in the energy consumption upon increasing power under low powers at frequencies of 6 kHz and 11 kHz is well in accordance with the discharge behaviours at these frequencies. As illustrated in FIG. 4A and FIG. 4B, the discharge evolves from short arc mode to diffuse mode upon increasing power at low powers, accompanied by a longer propagation distance and a larger plasma volume. In contrast, at frequencies of 20 kHz and 40 kHz, the energy consumptions do not change much upon increasing power because the discharge directly operates at diffuse mode as seen in FIG. 4C. For all the frequencies, the optimum power for NOₓ production lies between 15 W and 30 W, and a further power increase yields a slightly higher energy consumption. Under the optimum power, the energy consumption can reach approximately 1.29 MJ/mol at 20 kHz and 40 kHz, the numbers are 1.34 MJ/mol and 1.39 MJ/mol for 6 KHz and 11 kHz, respectively.

### Example 4: NOₓ Production with Restricting Discharge Current

The effect of discharge current on NOₓ production was investigated by restricting the discharge current with a 100 kΩ resistance. The experiment is performed at a frequency of 6 kHz and an air flow rate of 1 SLM.

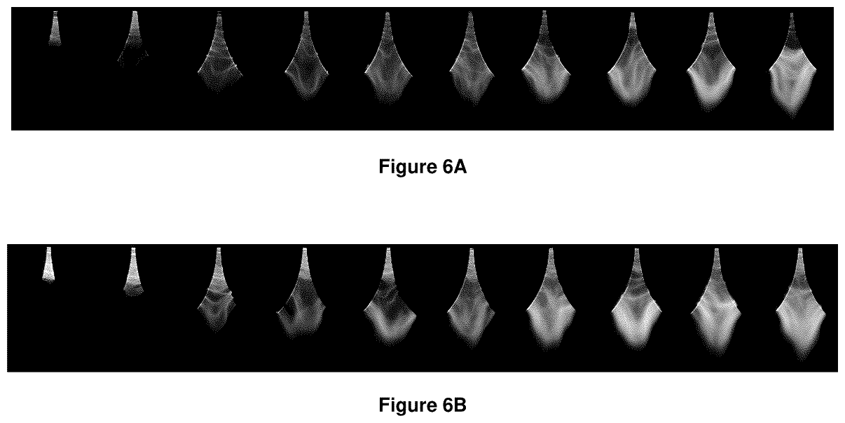

In FIG. 6, the discharge can sustain itself at a much lower power of about 5 W with a 100 kΩ resistance. For comparison, the lowest power to maintain a gliding arc without a resistance is about 8 W. Note the arc propagation distances are close at the lowest discharge power with or without restricting the current, indicating restricting current does not change the discharge mode at this frequency but lower the discharge power. Visually, the arc plasma in the upstream of the discharge region is much brighter without restricting the current when the discharge operates at low powers, whereas the discharge is more uniform with restricting current.

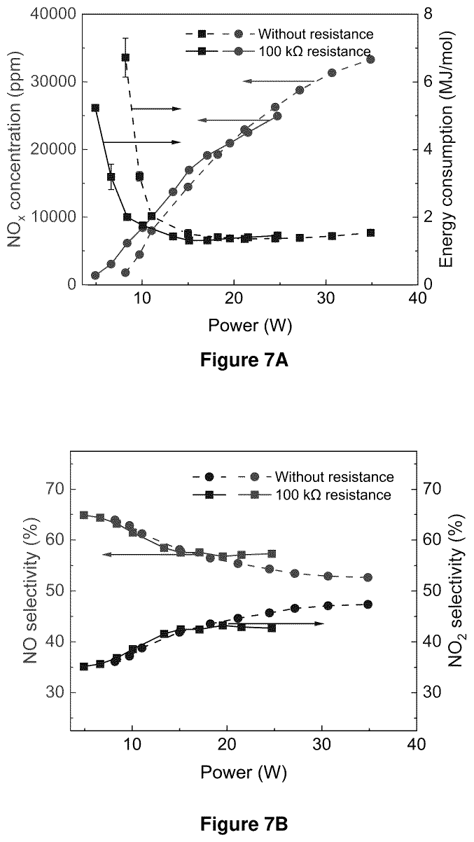

FIG. 7 shows the effects of restricting discharge current on NOₓ concentrations, NOₓ selectivity, and energy consumption of NOₓ production plotted as a function of discharge power. The NOₓ concentration at the lowest discharge power with restricting current is about 1400 ppm, lower that for 8 W without restricting current (1800 ppm), but the selectivity of NO is higher in the former case. Notably, at the same power of about 8 W, the NOₓ concentration can reach 6000 ppm with restricting the current, and therefore the energy consumption is merely one third of that without restricting the current. This is reasonable because at the same power of 8 W, the discharge clearly shows a different mode, short arc mode without restricting the current and diffuse glow-type mode with restricting the current, and as shown above the short arc mode is more energy consuming for NOₓ production. Actually, at discharge powers lower than 12 W, the energy consumptions of NOₓ production with restricting the current are significantly lower than these of the case without restricting the current, mainly due to the discharges are in different modes as clearly shown in FIG. 6.

However, the superiority of restricting discharge current begins to disappear upon further increasing the power above 12 W, because the discharge without restricting the current has transitioned into a diffuse glow-like mode. From the perspective of the overall energy input, restricting the current by employing a high value resistance is not encouraged because much energy is consumed by the resistor in the form of heat. For example, the resistor power and the temperature of the resistor can reach about 35 W and 200° C. at the optimum power of 15 W, and these values are even higher at higher powers. If the energy spent on the resistor is not used appropriately and efficiently, the overall energy efficiency of the system will be considerably low.

### Example 5: NOₓ Production at Different Flow Rates

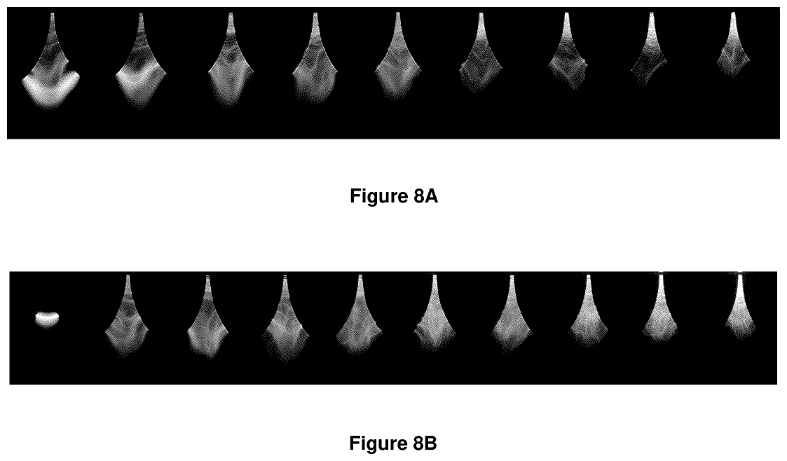

FIG. 8A and FIG. 8B shows the digital photos of gliding arc discharge upon increasing the flow rate at an applied frequency of 6 kHz and 40 KHz, at fixed powers of 21 W and 18 W, respectively, except for the first case at 40 kHz, where the power is 22 W in glow mode (feed gas: air).

FIG. 8 shows the discharge phenomena show different patterns upon increasing the flow rate at frequencies of 6 kHz and 40 kHz. The gliding arc is observed at a flow rate range of 0.5-2.5 SLM, and the power supply fails to sustain the gliding arc at 21 W when further increasing the flow rate at a frequency of 6 kHz. Differently, at 40 kHz, we observed static glow-type discharges at flow rates of 0.5 SLM and 0.75 SLM, and the gliding arc could operate at a higher maximum flow rate (4 SLM). Notably, the propagation distance decreases and the arcs become brighter and non-uniform upon increasing the flow rate.

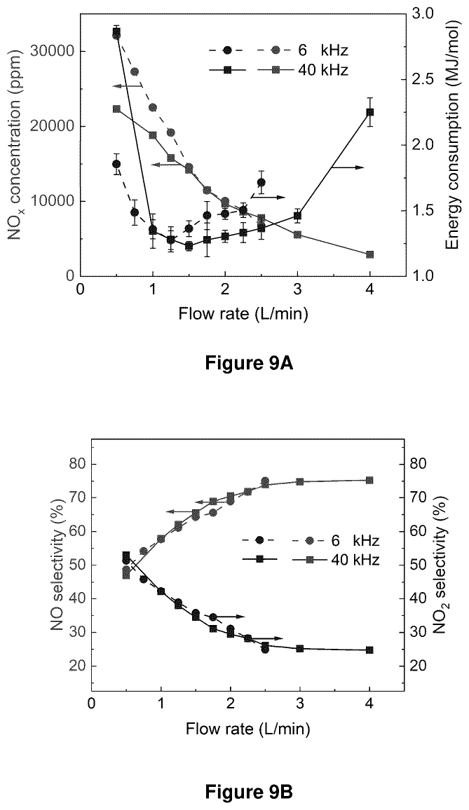

In FIG. 9, we see the effects of flow rate on the NOₓ concentrations, NOₓ selectivity, and energy consumption of NOₓ production at two distinct frequencies. When the discharge operates at a static glow-type mode as shown in FIG. 8, the energy consumption is considerably higher than these in gliding arc mode. The NOₓ concentrations decrease steadily upon increasing the flow rate at both frequencies, which is also the case for NO₂ selectivity. For example, at 6 kHz, the lowest flow rate gives the highest NO₂ selectivity (83%) and the NO₂ selectivity decreases almost linearly upon increasing the flow rate. Lower flow rate indicates longer residence time and therefore previously formed NO molecules are more likely oxidized into NO₂. However, too high or too low flow rate is not benefit for energy efficient NOₓ production.

As shown in FIG. 9B, the optimum gas flow rates at 6 kHz and 40 KHz are 1.25 SLM and 1.5 SLM, respectively. The corresponding energy consumptions are 1.28 MJ/mol and 1.23 MJ/mol at the optimum conditions. Low flow rate benefits from long propagation distance but suffers from high concentrations of products, whereas high flow rates could overcome the influence of high concentrations of products but it results in a short propagation distance and non-uniform discharge.

### Example 6: Nitrate/Nitrite Production by Absorbing NOₓ in Aqueous Solution

The produced NOₓ in the GAD device was firstly introduced to a post-discharge container to achieve suitable NO₂/NO ratio, and then the NOₓ was introduced to a vessel containing 100 mL solution to produce nitrate/nitrite from the reaction of NOₓ and solution.

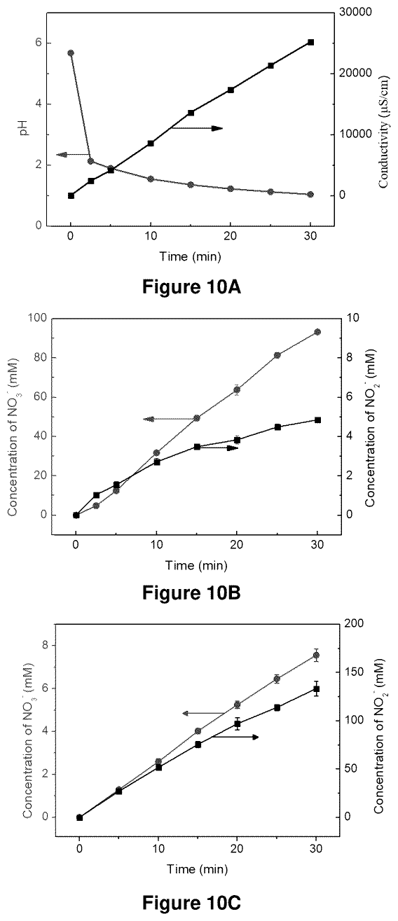

FIG. 10A shows pH and conductivity of aqueous solution in the acrylic cylindrical container at different discharge times using water as the absorbing solution at the optimum discharge condition for NOₓ production in terms of energy consumption (discharge power: 18 W, applied frequency: 40 kHz, flow rate: 1.5 SLM). The post-container used in this experiment has a length of 15 m, and the NO₂ selectivity increased from 34.5% to 68%. The pH drops sharply from 5.9 to 2.1 with a discharge time of 2.5 min, and then it further decreases with increasing discharge time. At a discharge time of 30 min, the pH reaches about 1. The conductivity of the solution increases almost linearly with increasing discharge time and it reaches approximately 25000 μs/cm at a discharge time of 30 min.

FIG. 10B shows concentrations of nitrate and nitrite in the solution at different discharge times. The concentrations of nitrate and nitrite both increase upon increasing discharge time. The concentration of nitrate increases almost linearly as the discharge time increases, and it reaches a value of about 100 mM at a discharge time of 30 min, while the value for nitrite at the same discharge time is only 5 mM. The concentration of nitrate in the solution is more than then times higher than that for nitrite, especially with a long discharge time, which is as a result of the high NO₂ selectivity in the NOₓ.

To achieve a high nitrite selectivity in the aqueous solution, the NO₂ selectivity in the NOₓ was adjusted to around 50% using a post-discharge container with a length of 5 m, and 1 M KOH solution was used as trapping solution.

FIG. 10C shows concentrations of nitrate and nitrite in the solution at different discharge times using 1 M KOH as trapping solution. Similar as the case using water as trapping solution, the concentrations of nitrate and nitrite both increase with increasing discharge time. Differently, the concentration of nitrite is much higher than the concentration of nitrate at all discharge time; the former reaches about 130 mM at a discharge time of 30 min and the number for the latter is about 7.5 mM. Therefore in this case, solution with high nitrite selectivity is obtained

### Example 7: Ammonia Production from Electrolysis Using Co(OH)₂ Catalyst Supporting on Different Conductive Substrates

Concentration of nitrate solution: 0.1 M; concentration of KOH: 1 M

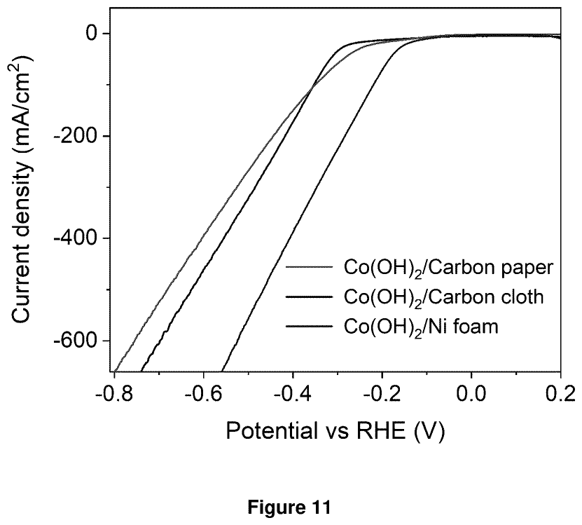

FIG. 11 shows LSV curves of Co(OH) 2 on carbon cloth, carbon paper and Ni foam in the electrolysis producing ammonia from standard electrolyte containing 0.1 M nitrate and 1 M KOH. The current densities of both curves stay around 0 mA/cm² as the potential is higher than −0.1 V versus RHE. The current density of LSV curve of Co(OH)₂ on Ni foam begins to drop at a potential of around −0.12 V versus RHE, while the potential for Co(OH)₂ on carbon cloth and carbon paper is around −0.2 V versus RHE. After the dropping point, at which the current density begin to drop sharply with decreasing potential, the current densities decrease at a similar speed with decreasing potential for Co(OH)₂ on all types of conductive substrate.

The current density of LSV curve of Co(OH) 2 on Ni foam reaches −650 mA/cm² at a potential of −0.56 V versus RHE, and at the same potential, the current densities of LSV curves of Co(OH)₂ on carbon cloth and carbon paper are −391 mA/cm² and −331 mA/cm². Clearly, Co(OH)₂ on Ni foam has a higher activity than it on other substrates, possibly because of the 3 D porous structure of Ni foam. In the following example, Ni foam was used as the conductive substrate.

### Example 8: Ammonia Production from Electrolysis Using Different Catalysts Comprising Cobalt Supporting on a Ni Foam

Concentration of nitrate solution: 0.1 M; concentration of KOH: 1 M

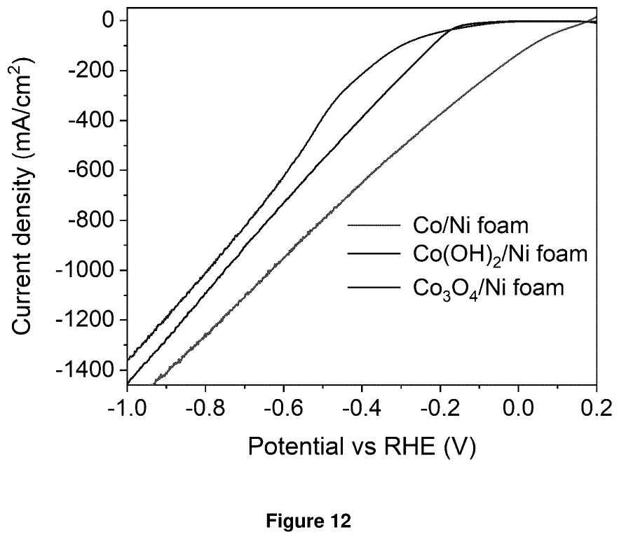

FIG. 12 shows LSV curves of Co(OH) 2/Ni foam, Co/Ni foam, and Co₃O₄/Ni foam in the electrolysis producing ammonia from standard electrolyte containing 0.1 M nitrate and 1 M KOH. The current densities of LSV curves of Co(OH)₂ on Ni foam and Co₃O₄ on Ni foam both stay around 0 mA/cm² as the potential is higher than −0.0 V versus RHE. The current density of LSV curve of Co on Ni foam begins to drop at a potential of around 0.17 V versus RHE, while the potential for Co(OH)₂ on Ni foam and CO₃O₄ on Ni foam is around −0.17 V versus RHE. After the dropping point, at which the current density begin to drop sharply with decreasing potential, the current densities decrease at a roughly similar speed with decreasing potential for all catalysts comprising cobalt on Ni foam.

The absolute value of LSV curve of Co on Ni foam is higher than that of Co(OH)₂ and Co₃O₄ at a potential range from 0.1 V versus RHE to −1.0 V versus RHE, especially at a potential range from −0.2 V versus RHE to −0.5 V versus. For example, the current density of LSV of Co on Ni foam reaches −648 mA/cm² at a potential of −0.4 V versus RHE, and at the same potential, the current densities of LSV curves of Co(OH)₂ on Ni foam and Co₃O₄ on Ni foam are −388 mA/cm² and −212 mA/cm². From the above example, it can be seen that Co on Ni foam has a higher activity than Co(OH)₂ and CO₃O₄. In the following example, Co on Ni foam was used as the catalyst.

### Example 9: Ammonia Production from Electrolysis Using Co/Ni Foam at Different Concentrations of KOH

Concentration of nitrate solution: 0.1 M; catalyst: Co/Ni foam

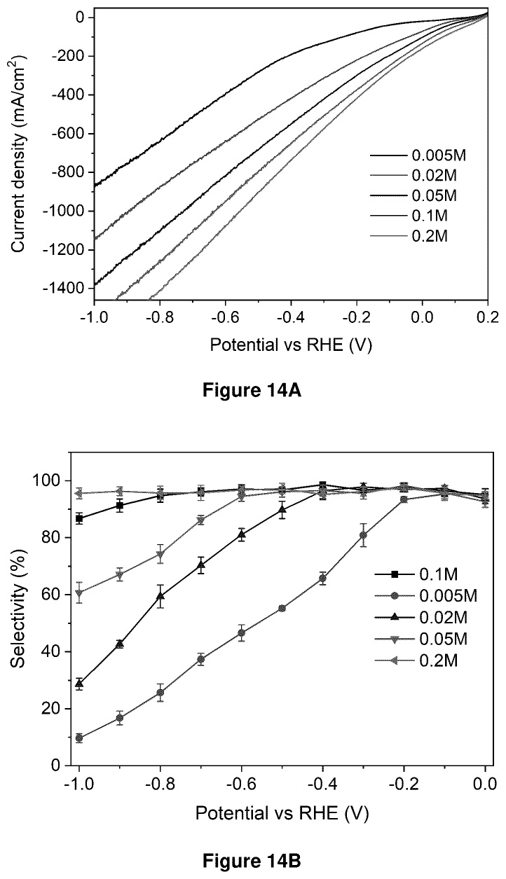

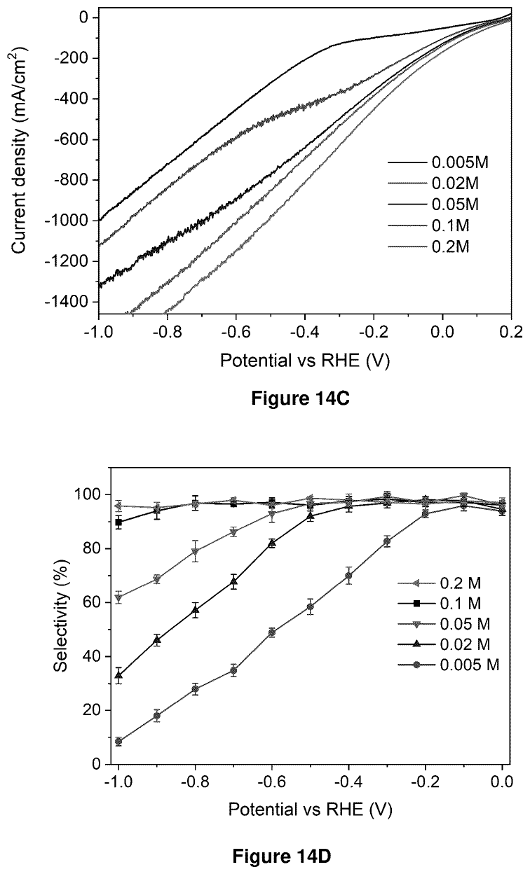

FIG. 14A shows LSV curves of Co/Ni foam at different concentrations of KOH (0.0 M, 0.1 M, 0.5 M, and 1 M) using nitrate solution as nitrogen source. The absolute value of LSV curves is higher at higher concentrations of KOH at a potential range from −0.2 V versus RHE to −0.2 V versus RHE, indicating the catalyst possesses higher activity at more alkaline environment. For example, at a potential of −0.8 V versus RHE, the current density reaches −1270 mA/cm² at 1 M KOH solution, while it only reaches −658 mA/cm², −390 mA/cm², and −154 mA/cm² when the electrolysis was conducted in 0.5 M, 0.1 M, and 0 M KOH solution.

FIG. 14B shows the Faradic efficiency of nitrate toward ammonia using Co/Ni foam as catalyst at different concentrations of KOH (0.0 M, 0.1 M, 0.5 M, and 1 M). The Faradic efficiencies of nitrate toward ammonia are similar at different concentrations of KOH; they are all above 90% when the potential is higher than −0.9 V versus RHE. Combing the current density and Faradic efficiency at different concentrations of KOH, high concentrations of KOH is favoured as it possesses higher ammonia production rates.

FIG. 14C shows LSV curves of Co/Ni foam at different concentrations of KOH (0.0 M, 0.1 M, 0.5 M, and 1 M) using nitrite solution as nitrogen source. The absolute value of LSV curves is higher at higher concentrations of KOH at a potential range from −0.2 V versus RHE to −0.2 V versus RHE, indicating the catalyst possesses higher activity at more alkaline environment, the same as the trend when nitrate is used as nitrogen source.

FIG. 14D shows the Faradic efficiency of nitrate toward ammonia using Co/Ni foam as catalyst at different concentrations of KOH (0.0 M, 0.1 M, 0.5 M, and 1 M). The Faradic efficiencies of nitrate toward ammonia are similar at different concentrations of KOH; they are all above 90% when the potential is higher than −0.9 V versus RHE, the same as the trend when nitrate is used as nitrogen source. Combing the current density and Faradic efficiency at different concentrations of KOH, high concentrations of KOH favours higher ammonia production rates.

### Example 11: Ammonia Production from Electrolysis Using Co/Ni Foam as a Catalyst at Different Concentrations of Nitrate/Nitrite

Concentration of KOH: 1 M

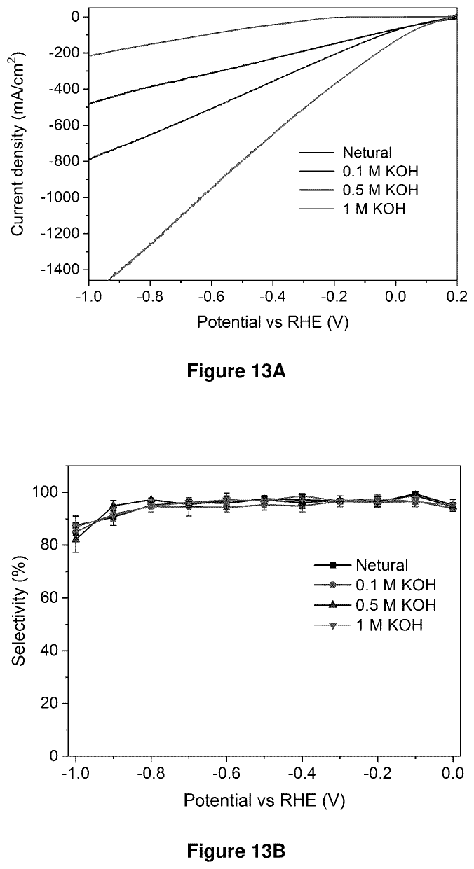

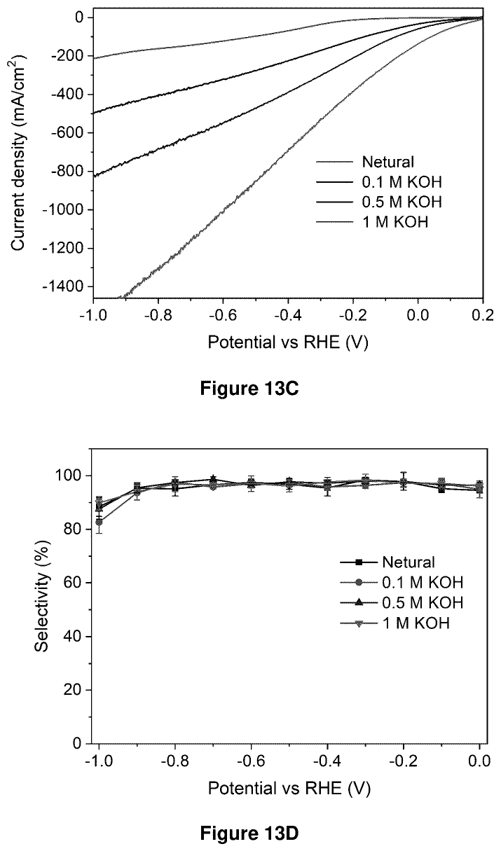

FIG. 13A shows LSV curves of Co/Ni foam at different concentrations of nitrate (0.005 M, 0.02 M, 0.05 M, 0.1 M, and 0.2 M). The absolute value of LSV curves is higher at higher concentrations of nitrate at a potential range from −0.2 V versus RHE to −0.2 V versus RHE, indicating the catalyst possesses higher activity at higher concentrations of nitrate. For example, at a potential of −0.8 V versus RHE, the current density reaches −1410 mA/cm² at 0.2 M nitrate solution, while it attains −1269 mA/cm², −1103 mA/cm², and −636 mA/cm² when the electrolysis was conducted in 0.1 M, 0.05 M, 0.02 M and 0.005 M KOH solution.

FIG. 14B shows the Faradic efficiency of nitrate toward ammonia using Co/Ni foam as catalyst at different concentrations of nitrate (0.005 M, 0.02 M, 0.05 M, 0.1 M, and 0.2 M). At a nitrate concentration of 0.2 M, the Faradic efficiency stays above 90% at all potentials ranging from 0.2 V versus RHE to −1.0 V versus RHE. Similar trend of the Faradic efficiency can be observed at a nitrate concentration of 0.1 M, except for the potential of −1.0 V versus RHE, which has a Faradic efficiency of 88%. At a nitrate concentration of 0.05 M, the Faradic efficiency stays above 90% at potentials higher than −0.5 V versus RHE, and it begins to decrease almost linearly with decreasing potential. At lower nitrate concentrations, the Faradic efficiency begins to drop at a higher potential. Combing the current density and Faradic efficiency at different concentrations of nitrate, high concentrations of nitrate favours higher ammonia production rates as a result of higher activity of catalyst and higher Faradic efficiency toward ammonia.

FIG. 13A shows LSV curves of Co/Ni foam at different concentrations of nitrite (0.005 M, 0.02 M, 0.05 M, 0.1 M, and 0.2 M). The absolute value of LSV curves is higher at higher concentrations of nitrite at a potential range from −0.2 V versus RHE to −0.2 V versus RHE, indicating the catalyst possesses higher activity at higher concentrations of nitrite, the same as the trend when nitrate is used as nitrogen source.

FIG. 14B shows the Faradic efficiency of nitrite toward ammonia using Co/Ni foam as catalyst at different concentrations of nitrite (0.005 M, 0.02 M, 0.05 M, 0.1 M, and 0.2 M). At a nitrite concentration of 0.2 M, the Faradic efficiency stays above 90% at all potentials ranging from 0.2 V versus RHE to −1.0 V versus RHE. Similar trend of the Faradic efficiency can be observed at a nitrite concentration of 0.1 M, except for the potential of −1.0 V versus RHE. At lower nitrite concentrations, the Faradic efficiency begins to drop at a higher potential, the same as the trend when nitrate is used as nitrogen source. Combing the current density and Faradic efficiency at different concentrations of nitrite, high concentrations of nitrite favour higher ammonia production rates as a result of higher activity of catalyst and higher Faradic efficiency toward ammonia.

### Example 12: Ammonia Production from Electrolysis Using Co/Ni Foam as a Catalyst and Plasma-Activated Solution as Working Electrolyte

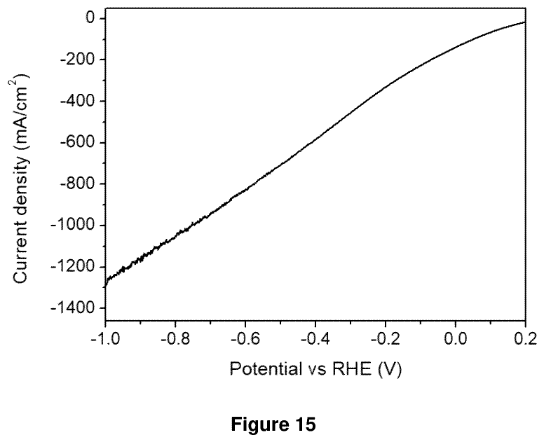

FIG. 15A shows LSV curve of Co/Ni foam using plasma-activated solution in the acrylic cylindrical container. (Discharge time: 30 min, 1 M KOH as absorbing solution, discharge power: 18 W, flow rate: 1.5 SLM, concentration of nitrate: 7.5 mM, concentration of nitrite: 130 mM). The LSV curve of Co/Ni foam using plasma-activated solution is similar to that of using 0.1 M nitrite solution in 1 M KOH.

Table 1 below provides a summary of the results.

TABLE 1
Ammonia production rate, Faradic efficiency, energy consumption
of ammonia production in the electrolysis, and energy consumption
from air with full NOₓ absorption^{a} at different potentials

| | | | | | Energy |
|---|---|---|---|---|---|
| | | | | Energy | consumption |
| Poten- | | | | consumption | from air with |
| tial (V | Ammonia production | | Faradic | in | full NOₓ |
| versus | rate | | efficiency | electrolysis | absorption |
| RHE) | mmol/h/cm² | mg/h | (%) | (MJ/mol) | ^{b} (MJ/mol) |
| −0.9 | 7.14 | 30.35 | 85 | 0.61 | 1.84 |
| −0.7 | 6.29 | 26.73 | 91 | 0.45 | 1.68 |
| −0.5 | 4.58 | 19.47 | 92 | 0.32 | 1.55 |
| −0.3 | 2.98 | 12.67 | 96 | 0.18 | 1.41 |
| −0.1 | 1.46 | 6.21 | 94 | 0.06 | 1.29 |

^{a}Optimized energy consumption of NOₓ production + energy consumption of ammonia production in electrolysis

### Example 13: Plasma Synthesis of NO₂ Rich NOₓ from Air Using a Gliding Arc Reactor

A further experiment was carried out as follows:

A flat GAD reactor used in this study contains two diverging stainless-steel electrodes (60 mm in length, 18 mm in width) installed 3 mm downstream of the nozzle exit with the narrowest gap of 2 mm. The GAD reactor was connected to an AC high voltage neon transformer with a maximum peak-to-peak voltage of 10 kV and a fixed frequency of 50 Hz. The applied voltage was measured by a high voltage probe (Testec, TT-HVP 15 HF), while arc current was recorded by a current monitor (Magnelab CT-E0.5). A four-channel digital oscilloscope (Tektronix, MDO3024) was used to sample the electrical signals. The discharge power was determined via the integral of applied voltage multiplied by arc current. The gas temperature in the GAD reactor was measured by a fibre optic thermometer (Omega, FOB102) with the fibre positioned at 70 mm downstream of the nozzle exit.

Air (Zero grade, BOC) was used as the reactant and introduced into the DBD reactor by a mass flow controller (Omega, FMA-2404). The gas products were analysed using an online Fourier-transform infrared (FTIR) spectrometer (FTIR-4200, Jasco) with a resolution of 0.5 cm⁻¹. The effluent gases passed a standard gas cell with a 10 cm path length placed in the FTIR. The products from the air GAD were determined as NO and NO₂ in all working conditions and the sum of their concentrations was defined as NOₓ concentration. Calibration gases with known concentrations of NO and NO₂ diluted in N₂ were used to quantify the concentration of these products. Each experiment was repeated 3 times, and the margin of error in this work was within 3%. The total gas flow rate was 2.8-4.0 L/min and the discharge power was 24-38 W, resulted in the specific energy input (SEI) ranged between 450 and 814 J/L.

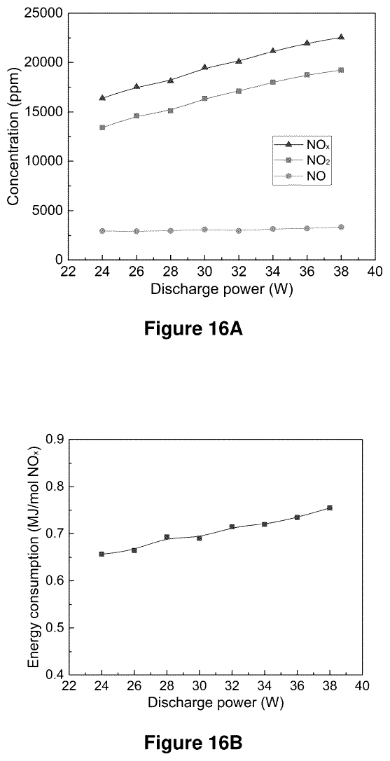

NO₂ and NO were found as the dominant products in this process. FIG. 16A demonstrates the overall NOₓ concentration increased from 16374 to 22555 with the increase of discharge power from 24 to 38 W. FIG. 16B demonstrates that the energy consumption of NOₓ synthesis increased from 0.66 to 0.76 MJ/mol NOₓ when increasing the discharge power from 24 to 38 W, suggesting a low discharge power leads to lower energy consumption of NOₓ production. Within the test range, the lowest energy consumption was 0.66 MJ/mol NOₓ at a discharge power of 24 W.

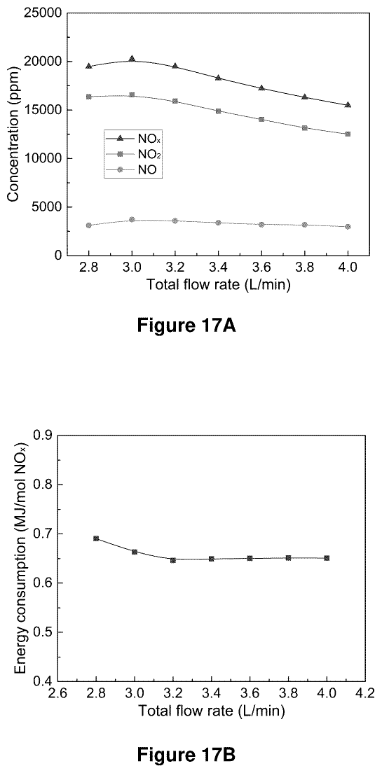

The concentration of individual NO₂ and NO and overall NOₓ showed identical trend with the increase of total flow rate, as shown in FIG. 17A. The concentration of NOₓ increased from 2.8 to 3.0 SLM and reached the maximum value of 20271 ppm at 3.0 SLM, after which it declined linearly to 15846 ppm at a total flow rate of 4.0 SLM. The concentrations of NO₂ and NO also reached the peak values of 16563 and 3709 ppm at a gas flow rate of 3.0 SLM, respectively. FIG. 17B demonstrates the influence of total gas flow rate on the energy consumption of NOₓ synthesis. The energy consumption of NOₓ synthesis slightly dropped when increasing the total flow rate from 2.8 SLM to 3.2 SLM, after which it remained stable at 0.65 MJ/mol NOₓ with the increase of total flow rate until 4.0 SLM. Notably, the minimum energy consumption of NOₓ synthesis (0.65 MJ/mol NOₓ) was achieved at the highest total flow rate of 4.0 SLM.

1. According to a first aspect of the present invention, there is provided an apparatus for forming NOₓ from nitrogen and oxygen, the apparatus comprising:
a gliding arc discharge, GAD, device arranged to generate a plasma;
a passageway including an inlet for a feed gas comprising nitrogen and oxygen and an outlet for the NOₓ, wherein the passageway extends, at least in part, through the GAD device wherein, in use, the nitrogen and oxygen are reacted in the generated plasma, thereby forming the NOₓ from at least some of the nitrogen and oxygen; and
a post-discharge container for adjusting the NO2/NO ratio in the formed NOₓ to from 1:2 to 2:1.

2. The apparatus according to claim 1, wherein the post-discharge container comprises a micro-porous membrane dividing the container into two parts.

3. The apparatus according to claim 1, wherein the apparatus further comprises a means for converting the NOₓ to ammonia.

4. The apparatus according to claim 3, wherein the means for converting the NOₓ to ammonia is an electrochemical means, suitably comprising a H-type cell arranged as a divided electrochemical cell.

5. The apparatus according to claim 4, wherein the divided electrochemical cell comprises a working electrode comprising an electrocatalyst comprising cobalt or nickel.

6. The apparatus according to claim 1, wherein the nitrogen and oxygen are reacted in the generated plasma at temperatures of at most 300° C.

7. The apparatus according to claim 1, wherein the feed gas is air.

8. The apparatus according to claim 1, wherein the GAD device comprises at least a pair of diverging electrodes.

9. A method of forming NOₓ from nitrogen and oxygen, the method comprising:
generating a plasma using a gliding arc discharge, GAD, device; and
reacting the nitrogen and oxygen in the generated plasma, thereby forming the NOₓ from at least some of the nitrogen and oxygen adjusting the NO2/NO ratio in the formed NOₓ to from 1:2 to 2:1.

10. The method according to claim 9, wherein the method comprises reacting air comprising nitrogen and oxygen in the generated plasma.

11. A method of synthesising ammonia, the method comprising:
(a) reacting the NOₓ obtained from claim 9 with an aqueous solution to form nitrate/nitrite from at least some of the NOₓ; and
(b) electrochemically reducing the nitrate/nitrite obtained in step (a) to ammonia.

12. The method according to claim 9, wherein reacting the methane in the generated plasma at temperatures less than 300° C.

13. The method according to claim 11 wherein step (b) involves applying a potential on the working electrode in a H-type cell.

14. The method according to claim 13 wherein step (b) occurs on a catalyst comprising cobalt and/or nickel, suitably consisting essentially of cobalt, supported on a conductive substrate.

15. Use of a catalyst comprising Co metal film in the electrochemical reduction of nitrate and/or nitrite to ammonia.

16. The apparatus according to claim 1, wherein the nitrogen and oxygen are reacted in the generated plasma at temperatures of at most 250° C.

17. The apparatus according to claim 8, wherein the at least a pair of diverging electrodes, comprises diverging steel electrodes.

18. The method according to claim 9, wherein reacting the methane in the generated plasma at temperatures of less than 250° C.
